(19) United States
(12) Patent Application Publication
(10) Pub. No.: US 2024/0397541 A1
(43) Pub. Date: Nov. 28, 2024

(54) NEAR-REAL TIME RADIO ACCESS NETWORK (RAN) INTELLIGENT CONTROLLER MACHINE LEARNING ASSISTED ADMISSION CONTROL

(71) Applicant: CommScope Technologies LLC, Claremont, NC (US)

(72) Inventors: Suman Saurav, Bhagalpur (IN); Harsha Hegde, Buffalo Grove, IL (US)

(73) Assignee: CommScope Technologies LLC, Claremont, NC (US)

(21) Appl. No.: 18/645,078

(22) Filed: Apr. 24, 2024

Related U.S. Application Data
(60) Provisional application No. 63/504,501, filed on May 26, 2023.

(51) Int. Cl. H04W 72/542; H04W 72/04; H04W 72/543

(52) U.S. Cl. CPC H04W 72/542; H04W 72/04; H04W 72/543

(57) ABSTRACT

Systems and methods for radio intelligent controller machine learning assisted admission control are provided. In one example, a method includes receiving performance indicator(s) for standalone UEs and performance indicator(s) for non-standalone UEs from BBU(s) of a base station. The base station includes the BBU(s), a first radio unit, and antenna(s) configured to implement a base station for wirelessly communicating with user equipment in a cell. The method includes determining predicted traffic parameter(s) for standalone UEs based on the received performance indicator(s) for standalone UEs from the BBU(s) and determining predicted traffic parameter(s) for non-standalone UEs based on the received performance indicators for non-standalone UEs from the BBU(s). The method includes allocating resources for standalone and/or non-standalone UEs based on the predicted traffic parameter(s) for standalone UEs, the predicted traffic parameter(s) for non-standalone UEs, and service requirements for the base station.

### CROSS-REFERENCE TO RELATED APPLICATIONS

This application claims priority to U.S. Provisional Application No. 63/504,501, filed on May 26, 2023, and titled “NEAR-REAL TIME RADIO ACCESS NETWORK (RAN) INTELLIGENT CONTROLLER MACHINE LEARNING ASSISTED ADMISSION CONTROL,” the contents of which are incorporated by reference herein in their entirety.

### BACKGROUND

A centralized or cloud radio access network (C-RAN) is one way to implement base station functionality. Typically, for each cell (that is, for each physical cell identifier (PCI)) implemented by a C-RAN, one or more baseband unit (BBU) entities (also referred to herein simply as “BBUs”) interact with multiple radio units (also referred to here as “RUs,” “remote units,” “radio points,” or “RPs”) in order to provide wireless service to various items of user equipment (UEs). The one or more BBU entities may comprise a single entity (sometimes referred to as a “baseband controller” or simply a “baseband band unit” or “BBU”) that performs Layer-3, Layer-2, and some Layer-1 processing for the cell. The one or more BBU entities may also comprise multiple entities, for example, one or more central units (CU) entities that implement Layer-3 and non-time critical Layer-2 functions for the associated base station and one or more distributed units (DUs) that implement the time critical Layer-2 functions and at least some of the Layer-1 (also referred to as the Physical Layer) functions for the associated base station. Each CU can be further partitioned into one or more user-plane and control-plane entities that handle the user-plane and control-plane processing of the CU, respectively. Each such user-plane CU entity is also referred to as a “CU-UP,” and each such control-plane CU entity is also referred to as a “CU-CP.” In this example, each RU is configured to implement the radio frequency (RF) interface and the physical layer functions for the associated base station that are not implemented in the DU. The multiple RUs may be located remotely from each other (that is, the multiple RUs are not co-located) or collocated (for example, in instances where each RU processes different carriers or time slices), and the one or more BBU entities are communicatively coupled to the RUs over a fronthaul network.

### SUMMARY

In some aspects, a system is described herein. The system includes at least one baseband unit (BBU) entity. The system further includes a first radio unit communicatively coupled to the at least one BBU entity via a fronthaul network. The system further includes one or more antennas communicatively coupled to the first radio unit, wherein the first radio unit is communicatively coupled to a respective subset of the one or more antennas. The at least one BBU entity, the first radio unit, and the one or more antennas are configured to implement a base station for wirelessly communicating with user equipment in a first cell. The system further includes a machine learning computing system communicatively coupled to the at least one BBU entity. The machine learning computing system is configured to: receive one or more performance indicators for standalone user equipment and one or more performance indicators for non-standalone user equipment from the at least one BBU entity; determine one or more predicted traffic parameters for standalone user equipment based on the received one or more performance indicators for standalone user equipment from the at least one BBU entity; and determine one or more predicted traffic parameters for non-standalone user equipment based on the received one or more performance indicators for non-standalone user equipment from the at least one BBU entity. One or more components of the system are configured to allocate resources for standalone user equipment and/or non-standalone user equipment based on the one or more predicted traffic parameters for standalone user equipment, the one or more predicted traffic parameters for non-standalone user equipment, and service requirements for the base station.

In some aspects, a method is described herein. The method includes receiving one or more performance indicators for standalone user equipment and one or more performance indicators for non-standalone user equipment from at least one baseband unit (BBU) entity of a base station. The base station includes the at least one BBU entity, a first radio unit, and one or more antennas configured to implement a base station for wirelessly communicating with user equipment in a cell. The method further includes determining one or more predicted traffic parameters for standalone user equipment based on the received one or more performance indicators for standalone user equipment from the at least one BBU entity. The method further includes determining one or more predicted traffic parameters for non-standalone user equipment based on the received one or more performance indicators for non-standalone user equipment from the at least one BBU entity. The method further includes allocating resources for standalone user equipment and/or non-standalone user equipment based on the one or more predicted traffic parameters for standalone user equipment, the one or more predicted traffic parameters for non-standalone user equipment, and service requirements for the base station.

### BRIEF DESCRIPTION OF THE DRAWINGS

Understanding that the drawings depict only exemplary embodiments and are not therefore to be considered limiting in scope, the exemplary embodiments will be described with additional specificity and detail through the use of the accompanying drawings, in which:

FIGS. 1A-1D are block diagrams illustrating example radio access networks;

FIG. 2 illustrates a flow diagram of an example method of machine learning assisted resource allocation for admission control;

FIG. 3 illustrates a flow diagram of an example method of machine learning assisted operation for admission control;

FIG. 4 is a block diagram illustrating an example radio access network; and

FIG. 5 is a block diagram illustrating an example machine learning framework for admission control.

In accordance with common practice, the various described features are not drawn to scale but are drawn to emphasize specific features relevant to the exemplary embodiments.

### DETAILED DESCRIPTION

In the following detailed description, reference is made to the accompanying drawings that form a part hereof, and in which is shown by way of illustration specific illustrative embodiments. However, it is to be understood that other embodiments may be used and that logical, mechanical, and electrical changes may be made. Furthermore, the method presented in the drawing figures and the specification is not to be construed as limiting the order in which the individual acts may be performed. The following detailed description is, therefore, not to be taken in a limiting sense.

In some fifth generation (5G) New Radio (NR) networks, a base station is used to provide service to user equipment (UEs) operating in a standalone (SA) mode and UEs operating in a non-standalone (NSA) mode. Typically, the base station serves UEs operating in SA mode and NSA mode as they arrive in a cell, attempts to meet the quality of service (QoS) requirements for the UEs, and rejects UEs when there are no resources available to serve additional UEs. In some situations, the rejection of UEs is random and may violate the Service Level Agreement (SLA) of certain UEs, which can incur compensation costs on operators. There is a need for an admission control mechanism that can adapt to the dynamic nature of UE arrival and share resources among UEs to reduce Call Blocking Probability (CBR) and meet the SLA of each UE.

While the problems described above involve 5G NR systems, similar problems exist in LTE. Therefore, although the following embodiments are primarily described as being implemented for use to provide 5G NR service, it is to be understood the techniques described here can be used with other wireless interfaces (for example, fourth generation (4G) Long-Term Evolution (LTE) service) and references to “gNB” can be replaced with the more general term “base station” or “base station entity” and/or a term particular to the alternative wireless interfaces (for example, “enhanced NodeB” or “eNB”). Furthermore, it is also to be understood that 5G NR embodiments can be used in both SA and NSA modes (or other modes developed in the future), and the following description is not intended to be limited to any particular mode. Also, unless explicitly indicated to the contrary, references to “layers” or a “layer” (for example, Layer-1, Layer-2, Layer-3, the Physical Layer, the MAC Layer, etc.) set forth herein refer to layers of the wireless interface (for example, 5G NR or 4G LTE) used for wireless communication between a base station and user equipment).

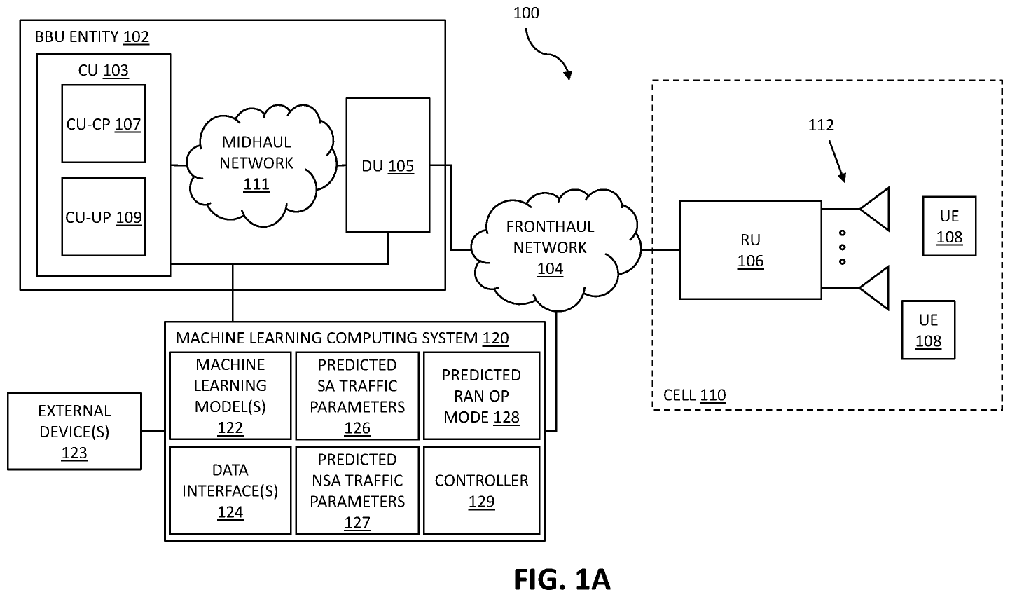

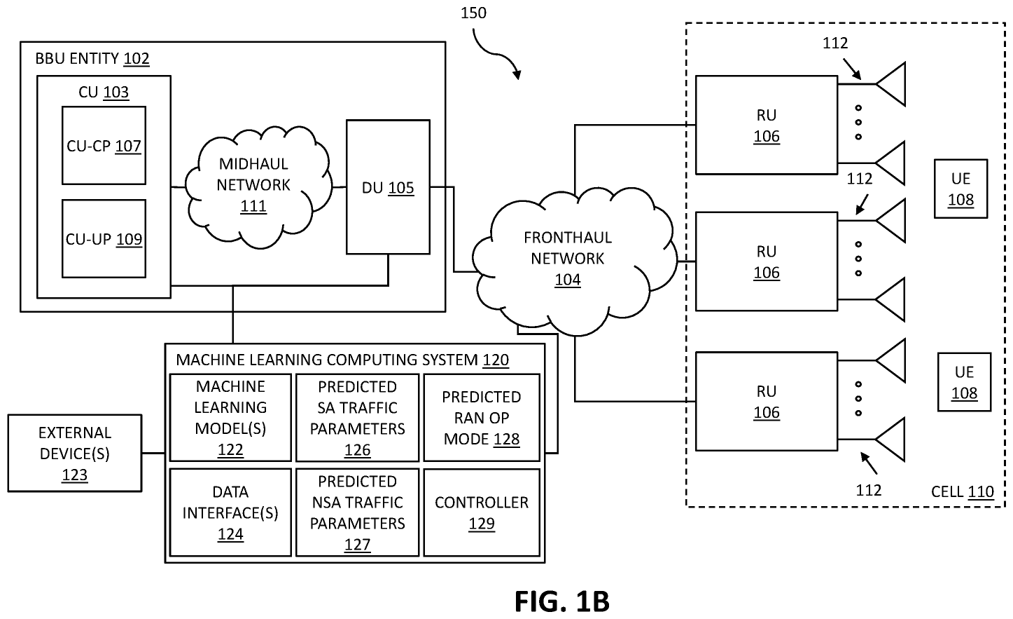

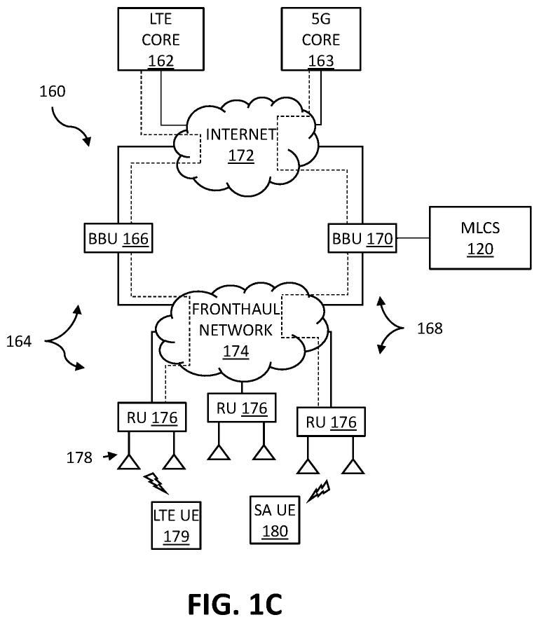

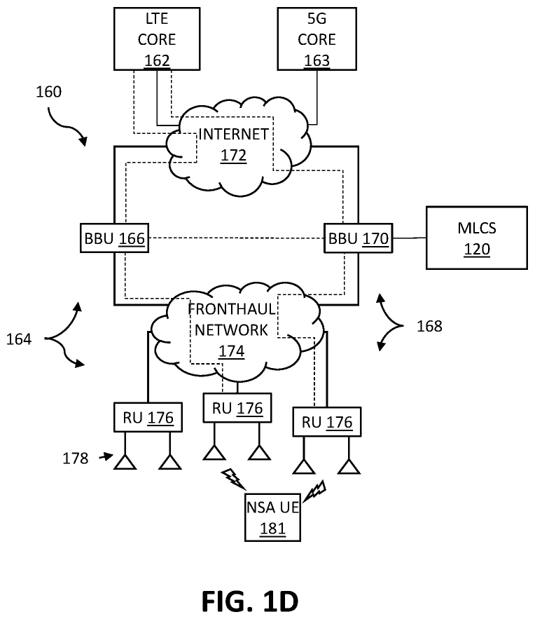

FIG. 1A is a block diagram illustrating an example base station 100 in which the techniques for machine learning assisted admission control described herein can be implemented. In the particular example shown in FIG. 1A, the base station 100 includes one or more baseband unit (BBU) entities 102 communicatively coupled to a RU 106 via a fronthaul network 104 and communicatively coupled to the core network 101 via a backhaul network 116. The base station 100 provides wireless service to various items of user equipment (UEs) 108 in a cell 110. Each BBU entity 102 can also be referred to simply as a “BBU.”

In the example shown in FIG. 1A, the one or more BBU entities 102 comprise one or more central units (CUs) 103 and one or more distributed units (DUs) 105. Each CU 103 implements Layer-3 and non-time critical Layer-2 functions for the associated base station 100. Each DU 105 is configured to implement the time critical Layer-2 functions and at least some of the Layer-1 (also referred to as the Physical Layer) functions for the associated base station 100. Each CU 103 can be further partitioned into one or more control-plane and user-plane entities 107, 109 that handle the control-plane and user-plane processing of the CU 103, respectively. Each such control-plane CU entity 107 is also referred to as a “CU-CP” 107, and each such user-plane CU entity 109 is also referred to as a “CU-UP” 109.

The RU 106 is configured to implement the control-plane and user-plane Layer-1 functions not implemented by the DU 105 as well as the radio frequency (RF) functions. The RU 106 is typically located remotely from the one or more BBU entities 102. In the example shown in FIG. 1A, the RU 106 is implemented as a physical network function (PNF) and is deployed in or near a physical location where radio coverage is to be provided in the cell 110. In the example shown in FIG. 1A, the RU 106 is communicatively coupled to the DU 105 using a fronthaul network 104. In some examples, the fronthaul network 104 is a switched Ethernet fronthaul network (for example, a switched Ethernet network that supports the Internet Protocol (IP)).

The RU 106 includes or is coupled to a set of antennas 112 via which downlink RF signals are radiated to UEs 108 and via which uplink RF signals transmitted by UEs 108 are received. In some examples, the set of antennas 112 includes two or four antennas. However, it should be understood that the set of antennas 112 can include two or more antennas 112. In one configuration (used, for example, in indoor deployments), the RU 106 is co-located with its respective set of antennas 112 and is remotely located from the one or more BBU entities 102 serving it. In another configuration (used, for example, in outdoor deployments), the antennas 112 for the RU 106 are deployed in a sectorized configuration (for example, mounted at the top of a tower or mast). In such a sectorized configuration, the RU 106 need not be co-located with the respective sets of antennas 112 and, for example, can be located at the base of the tower or mast structure, for example, and, possibly, co-located with its serving one or more BBU entities 102.

While the example shown in FIG. 1A shows a single CU-CP 107, a single CU-UP 109, a single DU 105, and a single RU 106 for the base station 100, it should be understood that this is an example and other numbers of BBU entities 102, components of the BBU entities 102, and/or other numbers of RUs 106 can also be used.

FIG. 1B is a block diagram illustrating an example base station 150 in which the techniques for machine learning assisted admission control described herein can be implemented. In the particular example shown in FIG. 1B, the base station 150 includes one or more BBU entities 102 communicatively coupled to multiple radio units RU 106 via a fronthaul network 104 and communicatively coupled to the core network 101 via a backhaul network 116. The base station 150 provides wireless service to various UEs 108 in a cell 110. Each BBU entity 102 can also be referred to simply as a “BBU.”

In the example shown in FIG. 1B, the one or more BBU entities 102 comprise one or more CUs 103 and one or more DUs 105. Each CU 103 implements Layer-3 and non-time critical Layer-2 functions for the associated base station 150. Each DU 105 is configured to implement the time critical Layer-2 functions and at least some of the Layer-1 (also referred to as the Physical Layer) functions for the associated base station 150. Each CU 103 can be further partitioned into one or more control-plane and user-plane entities 107, 109 that handle the control-plane and user-plane processing of the CU 103, respectively. Each such control-plane CU entity 107 is also referred to as a “CU-CP” 107, and each such user-plane CU entity 109 is also referred to as a “CU-UP” 109.

The RUs 106 are configured to implement the control-plane and user-plane Layer-1 functions not implemented by the DU 105 as well as the radio frequency (RF) functions. Each RU 106 is typically located remotely from the one or more BBU entities 102 and located remotely from other RUs 106. In the example shown in FIG. 1B, each RU 106 is implemented as a physical network function (PNF) and is deployed in or near a physical location where radio coverage is to be provided in the cell 110. In the example shown in FIG. 1B, the RUs 106 are communicatively coupled to the DU 105 using a fronthaul network 104. In some examples, the fronthaul network 104 is a switched Ethernet fronthaul network (for example, a switched Ethernet network that supports the Internet Protocol (IP)).

Each of the RUs 106 includes or is coupled to a respective set of antennas 112 via which downlink RF signals are radiated to UEs 108 and via which uplink RF signals transmitted by UEs 108 are received. In some examples, each set of antennas 112 includes two or four antennas. However, it should be understood that each set of antennas 112 can include two or more antennas 112. In one configuration (used, for example, in indoor deployments), each RU 106 is co-located with its respective set of antennas 112 and is remotely located from the one or more BBU entities 102 serving it and the other RUs 106. In another configuration (used, for example, in outdoor deployments), the sets of antennas 112 for the RUs 106 are deployed in a sectorized configuration (for example, mounted at the top of a tower or mast). In such a sectorized configuration, the RUs 106 need not be co-located with the respective sets of antennas 112 and, for example, can be located at the base of the tower or mast structure, for example, and, possibly, co-located with the serving one or more BBU entities 102. Other configurations can be used.

While the example shown in FIG. 1B shows a single CU-CP 107, a single CU-UP 109, a single DU 105, and three RUs 106 for the base station 150, it should be understood that this is an example and other numbers of BBU entities 102, components of the BBU entities 102, and/or other numbers of RUs 106 can also be used.

FIGS. 1C-1D are block diagrams of one exemplary embodiment of a wireless system in which the techniques for machine learning assisted admission control described herein can be used. In the example shown in FIGS. 1C-1D, the wireless system comprises a radio access network (RAN) 160 and multiple core networks 162, 163. In this example, the RAN 160 includes an LTE base station 164 (also referred to herein as “LTE Evolved Node B,” “eNodeB,” or “eNB”) and a 5G base station 168 (also referred to herein as “Next Generation Node B,” “gNodeB,” or “gNB”) that are used to provide UEs with mobile access to the wireless network operator's core networks 162, 163 in order to enable the UEs to wirelessly communicate data and voice.

In the example shown in FIGS. 1C-1D, the LTE core network 162 is implemented as an Evolved Packet Core (EPC) comprising standard LTE EPC network elements, and the 5G core network 163 is implemented as a 5G Core (5GC) comprising standard 5GC network elements. In the example shown in FIGS. 1C-1D, the back-haul between the RAN 160 and the core networks 162, 163 is implemented using one or more IP networks (including, in this example, the Internet 172).

The eNB 164 can be implemented using one or more baseband unit (BBU) entities 166 (also referred to herein simply as “BBUs”) that interact with multiple radio units 176 (also referred to here as “RUs,” “radio units,” “radio points,” or “RPs”) to implement the various base-station functions necessary to implement the air-interface and to interact with the LTE core network 162 in order to provide wireless service to various items of user equipment (UEs). In example shown in FIGS. 1C-1D, the one or more BBU entities 166 may comprise a single entity (sometimes referred to as a “baseband controller” or simply a “baseband band unit” or “BBU”) that performs Layer-3, Layer-2, and some Layer-1 processing for one or more cells. In this example, each RU 176 is configured to implement the radio frequency (RF) interface and the physical layer functions for the associated base station that are not implemented in the controller. The multiple radio units 176 are typically located remotely from each other (that is, the multiple radio units are not co-located), and the one or more BBU entities 166 are communicatively coupled to the radio units 176 over a fronthaul network 174. In some examples, the fronthaul network 174 is a switched Ethernet fronthaul network (for example, a switched Ethernet network that supports the Internet Protocol (IP)).

Similarly, the gNB 168 can be implemented using one or more baseband unit (BBU) entities 170 (also referred to herein simply as “BBUs”) that interact with multiple radio units 176 (also referred to here as “RUs,” “radio units,” “radio points,” or “RPs”) to implement the various base-station functions necessary to implement the air-interface and to interact with the LTE core network 162 in order to provide wireless service to various items of user equipment (UEs). In the example shown in FIGS. 1C-1D, the one or more BBU entities 170 include, for example, one or more central unit (CU) entities that implement Layer-3 and non-real time critical Layer-2 functions for the associated base station and one or more distribution units (DU) that implement the time critical Layer-2 functions and at least some of the Layer-1 (also referred to as the Physical Layer) functions for the associated base station. Each CU can be further partitioned into one or more user-plane and control-plane entities that handle the user-plane and control-plane processing of the CU, respectively. Each such user-plane CU entity is also referred to as a “CU-UP,” and each such control-plane CU entity is also referred to as a “CU-CP.” In this example, each RU 176 is configured to implement the radio frequency (RF) interface and the physical layer functions for the associated base station that are not implemented in the DU. The multiple radio units 176 are typically located remotely from each other (that is, the multiple radio units are not co-located), and the one or more BBU entities 170 are communicatively coupled to the radio units 176 over a fronthaul network 174. In some examples, the fronthaul network 174 is a switched Ethernet fronthaul network (for example, a switched Ethernet network that supports the Internet Protocol (IP)).

Each radio unit 176 includes or is coupled to one or more antennas 178 via which downstream radio frequency signals are radiated to UEs 108 and via which upstream radio frequency signals transmitted by user equipment 108 are received. In some examples, the one or more antennas 178 includes two or four antennas 178. In one configuration (used, for example, in indoor deployments), the RUs 176 are co-located with respective antennas 178 and remotely located from the one or more BBU entities 166, 170 serving it. In another configuration (used, for example, in outdoor deployments), the antennas 178 for the RUs 176 are deployed in a sectorized configuration (for example, mounted at the top of a tower or mast). In such a sectorized configuration, the RUs 176 need not be co-located with the respective antennas 178 and, for example, can be located at the base of the tower or mast structure, for example, and, possibly, co-located with its serving one or more BBU entities 166, 170.

In the example shown in FIGS. 1C-ID, the eNB 164 and the gNB 168 are implemented using the same radio units 176 and antennas 178. That is, the eNB 164 and the gNB 168 share radio units 176 and antennas 178. In other examples, the CNB 164 is implemented using respective radio units 176 and antennas 178 that are different than the radio units 176 and antennas 178 used to implement the gNB 168.

In the example shown in FIGS. 1C-1D, the RAN 160 is configured to support a combined mode of operation where UEs can be supported when operating in a standalone mode or a non-standalone mode. In some examples, the RAN 160 is configured to support one or more LTE cells and one or more NR cells, which can include one or more NR frequency division duplexing (FDD) cells and one or more NR time division duplexing (TDD) cells.

In the example shown in FIG. 1C, the eNB 164 is configured to operate in an LTE only mode (also referred to as Option 1) to serve the LTE UE 179, and the gNB 168 is configured to operate in a SA mode to serve the SA UE 180 (also referred to as Option 2). In LTE only mode, the eNB 164 provides both the control-plane and the user-plane connection to the EPC 162 for LTE UE 179. In SA mode, the gNB 168 provides both the control-plane and the user-plane connection to the 5GC 163 for the SA UE 180. The dashed lines in FIG. 1C represent the user-plane data paths for this particular implementation of the RAN 160.

In some examples, the eNB 164 and the gNB 168 are configured to operate in an NSA mode in addition to, or instead of, operating in an LTE only mode or a SA mode. Depending on the type of NSA mode, either the eNB 164 or the gNB 168 operates as the “Master Node” and the other operates as the “Secondary Node.” The “Master Node” is the radio access node that provides both a control-plane connection and a user-plane connection to a core network 162, 163 for the NSA UE 181 while the “Secondary Node” is the radio access node that provides additional user-plane resources for the NSA UE 181 but does not include a control-plane connection to a core network 162, 163 for the NSA UE 181.

In the example shown in FIG. 1D, a particular type of dual connectivity is shown where the eNB 164 is configured to operate as the “Master Node” and the gNB 168 is configured to operate as the “Secondary Node.” That is, the eNB 164 provides both a control-plane connection and a user-plane connection to the LTE core network 162 for the NSA UE 181, and the gNB 168 provides additional user-plane resources for the NSA UE 181. This type of dual connectivity is referred to as E-UTRA-NR Dual Connectivity (EN-DC) or an Option 3 configuration.

In the example shown in FIG. 1D, the eNB 164 communicates with the LTE core network 162 using the S1 interface and communicates with the gNB 168 using the X2 interface. In some examples, the gNB 168 communicates with components in the LTE core network 162 using the S1-U interface and communicates with the eNB 164 using the X2 interface. The dashed lines in FIG. 1D represent the user-plane data paths for a particular implementation of the RAN 160. In the example shown in FIG. 1D, the RAN 160 is shown in an Option 3x mode, but it should be understood that other non-standalone modes could also be implemented.

In the example shown in FIGS. 1C-1D, only one eNB 164 and only one gNB 168 are shown. It should be understood that a different number of eNBs 164 and/or gNB 168 could be used to implement the RAN 160. It should also be understood that the particular type of dual connectivity implemented using the RAN 160 could be different depending on the configuration. For example, the RAN 160 could be configured to provide NG-RAN E-UTRA-NR Dual Connectivity (NGEN-DC) or NR-E-UTRA Dual Connectivity (NE-DC) instead of EN-DC as discussed above.

The radio access network nodes that include the components shown in FIGS. 1A-1D can be implemented using a scalable cloud environment in which resources used to instantiate each type of entity can be scaled horizontally (that is, by increasing or decreasing the number of physical computers or other physical devices) and vertically (that is, by increasing or decreasing the “power” (for example, by increasing the amount of processing and/or memory resources) of a given physical computer or other physical device). The scalable cloud environment can be implemented in various ways. For example, the scalable cloud environment can be implemented using hardware virtualization, operating system virtualization, and application virtualization (also referred to as containerization) as well as various combinations of two or more of the preceding. The scalable cloud environment can be implemented in other ways. In some examples, the scalable cloud environment is implemented in a distributed manner. That is, the scalable cloud environment is implemented as a distributed scalable cloud environment comprising at least one central cloud, at least one edge cloud, and at least one radio cloud.

In some examples, one or more components of the BBU entities 102, 166, 170 (for example, the CU, CU-CP, CU-UP, and/or DU) are implemented as a software virtualized entities that are executed in a scalable cloud environment on a cloud worker node under the control of the cloud native software executing on that cloud worker node. In some such examples, the DU is communicatively coupled to at least one CU-CP and at least one CU-UP, which can also be implemented as software virtualized entities. In some other examples, one or more components of the one or more BBU entities 102, 166, 170 (for example, the CU-CP, CU-UP, and/or DU) are implemented as a single virtualized entity executing on a single cloud worker node. In some examples, the at least one CU-CP and the at least one CU-UP can each be implemented as a single virtualized entity executing on the same cloud worker node or as a single virtualized entity executing on a different cloud worker node. However, it is to be understood that different configurations and examples can be implemented in other ways. For example, the CU can be implemented using multiple CU-UP VNFs and using multiple virtualized entities executing on one or more cloud worker nodes. Moreover, it is to be understood that the CU and DU can be implemented in the same cloud (for example, together in a radio cloud or in an edge cloud). In some examples, the DU 105 is configured to be coupled to the CU-CP 107 and CU-UP 109 over a midhaul network 111 (for example, a network that supports the Internet Protocol (IP)). Other configurations and examples can be implemented in other ways.

In the examples shown in FIGS. 1A-ID, the systems further include a machine learning computing system 120. In some examples, the machine learning computing system 120 is implemented using general-purpose computing devices (for example, a server) equipped with at least one (and optionally more than one) graphics processing unit (GPU) for faster machine-learning-based processing. In some examples, the machine learning computing system 120 is implemented in more than one physical housing, each with at least one graphics processing unit (GPU). In some examples, the machine learning computing system 120 is implemented using different computing resources than those used for processing communications signals in the CU, DU, or RUs, so the resources of the CU, DU, and RUs are not consumed by the machine learning computing system 120. In some examples, the machine learning computing system 120 is implemented using one or more hardware acceleration engines that support lightweight machine learning libraries.

In the examples shown in FIGS. 1A-1D, the machine learning computing system 120 implements one or more machine learning agent(s)/model(s) 122 configured to determine predicted traffic parameters for standalone user equipment 126. In some examples, the predicted traffic parameters for standalone user equipment 126 include, but are not limited to, a total number of RRC Connection Establishment Requests, a total number of RRC Connection Rejections where the cause was resources not being available, a total number of Guaranteed Bit Rate (GBR) bearers mapped to a Protocol Data Unit (PDU) session (including successful and rejected), a total number of non-GBR bearers mapped to a PDU session (including successful and rejected), a total number of PDU sessions (including successful and rejected), a total number of 5G Quality of Service Identifier (5QI) bearers (including successful and rejected), and/or a total number of inactive RRC contexts and a number of those inactive RRC contexts that became active. In some examples, the total number of 5QI bearers includes 5QI bearers related to IMS signaling (for example, a 5QI 5 bearer) and voice calls.

In the examples shown in FIGS. 1A-1D, the machine learning computing system 120 implements one or more machine learning agent(s)/model(s) 122 configured to determine predicted traffic parameters for non-standalone user equipment 127. In some examples, the predicted traffic parameters for non-standalone user equipment 127 include, but are not limited to, a total number of RRC Connection Establishment Requests, a total number of RRC Connection Rejections where the cause was resources not being available, a total number of GBR bearers mapped to a PDU session (including successful and rejected), a total number of non-GBR bearers mapped to a PDU session (including successful and rejected), a total number of PDU sessions (including successful and rejected), and/or a total number of 5QI bearers (including successful and rejected).

In addition to the types of performance indicators discussed above, it can also be helpful to consider the number of user equipment that are redirected from one mode of operation to another when considering the resources needed to meet SLA requirements. In some examples, the machine learning computing system 120 implements one or more machine learning agent(s)/model(s) 122 configured to determine a predicted total number of standalone user equipment that will be redirected to non-standalone mode and a predicted total number of non-standalone user equipment that will be redirected to standalone mode.

In the examples shown in FIGS. 1A-1D, the machine learning computing system 120 implements one or more machine learning agent(s)/model(s) 122 configured to determine a predicted RAN operation mode 128. In some examples, the modes for the predicted RAN operation mode 128 can include, but are not limited to, a standalone only operation mode, a non-standalone only operation mode, or a combination of standalone mode and non-standalone mode.

In some examples, the machine learning computing system 120 implements one or more machine learning agent(s)/model(s) 122 configured to determine a predicted cause for the predicted RAN operation mode 128. In some examples, the predicted causes can include, but are not limited to, normal operation, a mode change due to network error (for example, core network connectivity not available or X2/Xn resources for NSA mode not available), and a mode change due to operator (for example, reconfiguration).

In some examples, the system includes multiple machine learning computing systems 120, and each machine learning computing system 120 implements a single machine learning agent/model 122 such that each machine learning agent/model 122 uses separate computing resources. In some examples, at least one machine learning computing system 120 implements multiple machine learning agent(s)/model(s) 122 such that the machine learning agent(s)/model(s) shares computing resources.

In order to reliably predict the traffic parameters, total number of SA/NSA UEs that will be redirected, RAN operation mode, and cause of the RAN operation mode discussed above, the machine learning agent(s)/model(s) 122 of the machine learning computing systems 120 are trained using supervised learning, unsupervised learning, reinforcement learning, and/or other machine learning methods. The machine learning agent(s)/model(s) 122 of the machine learning computing systems 120 are trained using performance indicators from one or more components of the base stations (for example, the CU 103 or the DU 105). The machine learning method(s) can include online training (during operation), offline training (prior to operation), or a combination depending on the circumstances. In some examples, the machine learning agent(s)/model(s) 122 can be trained at the DU 105, RU 106, CU 103 respectively and/or at a different location or locations in the network. For example, the machine learning agent(s)/model(s) 122 can be trained offline at one location (for example, at a central server) and trained online when deployed. In general, the objective for training the machine learning agent(s)/model(s) 122 is to determine the predicted traffic parameters, the predicted RAN operation mode, and the predicted cause for the predicted RAN operation mode to a desired level of accuracy such that the CBR and service requirements for the base station can be met within acceptable margins of error. It should be understood that other techniques can also be used. For example, any of the techniques described in the O-RAN Working Group (WG) 2 Artificial Intelligence (AI) Machine Learning (ML) Technical Report (O-RAN.WG2.AIML-v01.03) (referred to herein as the “O-RAN AIML Technical Report”), which is incorporated herein by reference, can be used for training and deployment of the machine learning agent(s)/model(s) 122.

In the example shown in FIGS. 1A-1D, the machine learning computing system 120 further includes a controller 129. In some examples, the controller 129 is configured to allocate resources to standalone user equipment and/or non-standalone user equipment based on the predicted traffic parameters for standalone user equipment 126, the predicted traffic parameters for non-standalone user equipment 127, and service requirements for the base station. The service requirements for the base station can be defined (for example, in a SLA) and include, for example, minimum requirements for a number of standalone user equipment to be supported, a number of non-standalone user equipment to be supported, a number of GBR bearers to be supported, a number of non-GBR bearers to be supported, and/or a data rate to be supported for a duration of a period of time. The service requirements for the base station can be provided by the operator or another user via an interface during training such that the machine learning agent(s)/model(s) 122 can be trained using the service requirements. If the service requirements are updated during operation, the machine learning agent(s)/model(s) 122 can be retrained to accommodate those updates and resources are reallocated accordingly.

In some examples, the controller 129 is configured to reserve radio resources to standalone user equipment and non-standalone user equipment based on the predicted traffic parameters for standalone user equipment 126, the predicted traffic parameters for non-standalone user equipment 127, and the service requirements of the base station. In some examples, the controller 129 is configured to reserve an amount of radio resources for admission control for standalone user equipment and non-standalone user equipment that will meet the requirements in an SLA from an operator and reduce the call blocking probability/rate for user equipment. In some such examples, the controller 129 is configured to output control signals to one or more components of the radio access network (for example, the one or more components of the BBU 102, 166, 170 (for example, the CU 103 or the DU 105) to implement the allocation of resources.

In some examples, the controller 129 is configured to perform preemptive action based on available resources for the base station and the predicted RAN operation mode 128. In some such examples, performing preemptive action includes handing over user equipment from a first cell to a second cell, releasing and redirecting user equipment from a first cell to a second cell, and/or changing an operation mode of the user equipment (for example, from a standalone mode to a non-standalone mode). In some such examples, additional factors are considered for the preemptive action such as, for example, X2/Xn resource availability, UE capability, and the particular deployment (for example, whether a cell overlays another enabling).

In other examples, a different component of the radio access network (for example, the one or more components of the BBU 102, 166, 170 (for example, the CU 103 or the DU 105) is configured to allocate resources to standalone user equipment and non-standalone user equipment and/or perform preemptive action in a manner similar to that described above with respect to the controller 129. In some such examples, the CU 103 and/or DU 105 is configured to receive the predicted traffic parameters for standalone user equipment 126, the predicted traffic parameters for non-standalone user equipment 127, and the predicted RAN operation mode 128 from the machine learning computing system 120 and allocate resources to standalone user equipment and non-standalone user equipment and/or perform preemptive action.

In some examples, the predicted traffic parameters for standalone user equipment 126 and the predicted traffic parameters for non-standalone user equipment 127 may indicate that there is insufficient capacity to meet the service requirements for the base station. In some such examples, one or more components of the system are configured to output an alert or notification to the operator when the predicted traffic parameters indicated insufficient capacity. In some examples, one or more components of the system are configured to use scaling to increase radio resources for standalone user equipment and non-standalone user equipment in addition to, or instead of, outputting an alert or notification.

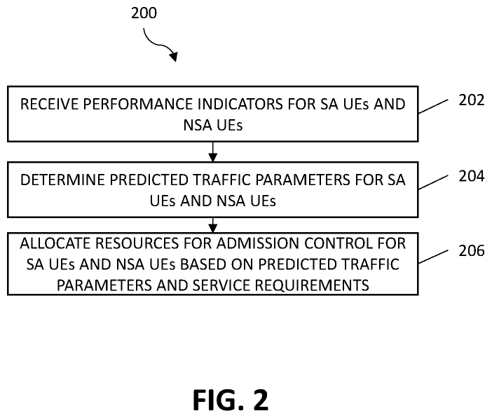

FIG. 2 illustrates a flow diagram of an example method of machine learning assisted resource allocation for admission control. The common features discussed above with respect to the base stations in FIGS. 1A-1D can include similar characteristics to those discussed with respect to method 200 and vice versa. In some examples, the blocks of the method 200 are performed by the machine learning computing system 120 alone or in combination with one or more components of a base station communicatively coupled to the machine learning computing system 120.

The blocks of the flow diagram in FIG. 2 have been arranged in a generally sequential manner for ease of explanation; however, it is to be understood that this arrangement is merely exemplary, and it should be recognized that the processing associated with method 200 (and the blocks shown in FIG. 2) can occur in a different order (for example, where at least some of the processing associated with the blocks is performed in parallel in an event-driven manner).

The method 200 includes receiving performance indicators for user equipment in standalone mode (also referred to herein as “standalone user equipment” or “SA UEs”) and user equipment in non-standalone mode (also referred to herein as “non-standalone user equipment” or “NSA UEs”) (block 202). In some examples, the performance indicators received for the SA UEs are similar to the performance indicators received for the NSA UEs. The performance indicators are received from one or more components of a base station for a particular duration of time. In some examples, the performance indicators for SA UEs include, but are not limited to, a total number of RRC Connection Establishment Requests, a total number of RRC Connection Rejections where the cause was resources not being available, a total number of GBR bearers mapped to a PDU session, a total number of non-GBR bearers mapped to a PDU session, a total number of PDU sessions, a total number of 5QI bearers, and/or a total number of inactive RRC contexts and a number of inactive RRC contexts that became active. In some examples, the performance indicators for NSA UEs include, but are not limited to, a total number of RRC Connection Establishment Requests, a total number of RRC Connection Rejections where the cause was resources not being available, a total number of GBR bearers mapped to a PDU session, a total number of non-GBR bearers mapped to a PDU session, a total number of PDU sessions, and/or a total number of 5QI bearers.

The method 200 further includes determining predicted traffic parameters for the SA UEs and the NSA UEs (block 204). In some examples, the predicted traffic parameters for the SA UEs are similar to the predicted traffic parameters for the NSA UEs. In some examples, determining predicted traffic parameters for the SA UEs and the NSA UEs includes determining the predicted traffic parameters for the SA UEs and NSA UEs for a future period of time using one or more machine learning models trained in a manner as discussed above. In some examples, the predicted traffic parameters for NSA UEs or SA UEs include, but are not limited to, a total number of RRC Connection Establishment Requests, a total number of RRC Connection Rejections where the cause was resources not being available, a total number of GBR bearers mapped to a PDU session, a total number of non-GBR bearers mapped to a PDU session, a total number of PDU sessions, and/or a total number of 5QI bearers for a duration of time.

The method 200 further includes allocating resources for admission control for SA UEs and NSA UEs based on the predicted traffic parameters for the SA UEs and the NSA UEs and service requirements for the base station (block 206). In some examples, allocating resources for admission control for SA UEs and NSA UEs includes allocating or reserving radio resources for a period of time. In some examples, the service requirements for the base station correspond to requirements in a service level agreement (SLA) for SA UEs and NSA UEs from an operator. For example, the service requirements can include minimum requirements for a number of standalone user equipment to be supported, a number of non-standalone user equipment to be supported, a number of GBR bearers to be supported, a number of non-GBR bearers to be supported, and/or a data rate to be supported for a duration of the period of time.

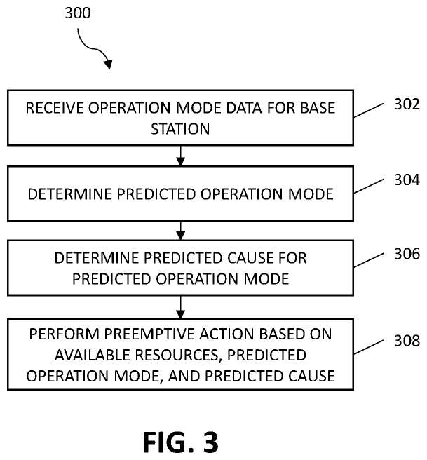

FIG. 3 illustrates a flow diagram of an example method of machine learning assisted operation for admission control. The common features discussed above with respect to the base stations in FIGS. 1A-1D can include similar characteristics to those discussed with respect to method 300 and vice versa. In some examples, the blocks of the method 300 are performed by the machine learning computing system 120 alone or in combination with one or more components of a base station communicatively coupled to the machine learning computing system 120.

The blocks of the flow diagram in FIG. 3 have been arranged in a generally sequential manner for ease of explanation; however, it is to be understood that this arrangement is merely exemplary, and it should be recognized that the processing associated with method 300 (and the blocks shown in FIG. 3) can occur in a different order (for example, where at least some of the processing associated with the blocks is performed in parallel in an event-driven manner).

The method 300 includes receiving operation mode data for a base station (block 302). In some examples, the operation mode data for a base station indicates whether the base station is operating in a standalone only mode, a non-standalone only mode, or a combined mode. In some examples, the operation mode data for the base station can be provided by a component of a BBU (for example, the CU).

The method 300 further includes determining a predicted operation mode for the base station (block 304). In some examples, determining the predicted operation mode for the base station includes determining the predicted operation mode for the base station for a future period of time using one or more machine learning models trained in a manner as discussed above. In some examples, the modes for the predicted RAN operation mode 128 can include, but are not limited to, a standalone only operation mode, a non-standalone only operation mode, or a combination of standalone mode and non-standalone mode.

The method 300 further includes determining a predicted cause for the predicted operation mode for the base station (block 306). In some examples, determining the predicted cause for the predicted operation mode for the base station includes determining the predicted cause for the predicted operation mode for the base station for a future period of time using one or more machine learning models trained in a manner as discussed above. In some examples, the predicted causes can include, but are not limited to, normal operation, a mode change due to network error (for example, core network connectivity not available or X2/Xn resources for NSA mode not available), and a mode change due to operator (for example, reconfiguration).

The method 300 further includes performing preemptive action based on available resources, the predicted operation mode for the base station, and the predicted cause for the predicted operation mode for the base station (block 308). In some such examples, performing preemptive action includes handing over user equipment from a first cell to a second cell (for example, from an LTE cell to an NR cell or vice versa), releasing and redirecting user equipment from a first cell to a second cell, and/or changing an operation mode of the user equipment (for example, from a standalone mode to a non-standalone mode).

In some examples, block 306 is optional and determining a predicted cause for the predicted operation mode for the base station is not performed for method 300. In such examples, block 308 includes performing preemptive action based on available resources and the predicted operation mode for the base station.

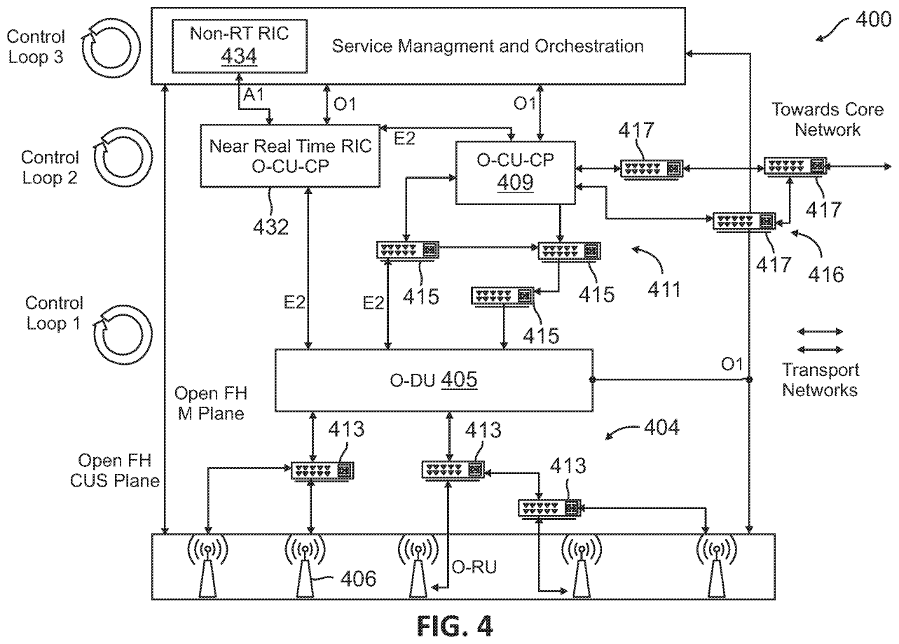

FIG. 4 is a block diagram illustrating an example base station 400 in which the techniques for machine learning assisted admission control described herein can be implemented. In the particular example shown in FIG. 4, the base station 400 includes one or more central units (CUs), one or more distributed units (DUs), and one or more radio units (RUS). Each RU is located remotely from each CU and DU serving it.

The base station 400 is implemented in accordance with one or more public standards and specifications. In some examples, the base station 400 is implemented using the logical RAN nodes, functional splits, and front-haul interfaces defined by the Open Radio Access Network (O-RAN) Alliance. In the example shown in FIG. 4, each CU, DU, and RU is implemented as an O-RAN central unit (O-CU), O-RAN distributed unit (O-DU) 405, and O-RAN radio unit (O-RU) 406, respectively, in accordance with the O-RAN specification.

In the example shown in FIG. 4, the base station 400 includes a single O-CU, which is split between an O-CU-CP (not shown) that handles control-plane functions and an O-CU-UP 409 that handles user-plane functions. The O-CU comprises a logical node hosting Packet Data Convergence Protocol (PDCP), Radio Resource Control (RRC), Service Data Adaptation Protocol (SDAP), and other control functions. Therefore, each O-CU implements the gNB controller functions such as the transfer of user data, mobility control, radio access network sharing, positioning, session management, etc. The O-CU(s) control the operation of the O-DUs 405 over an interface (including Fl-C and Fl-U for the control plane and user plane, respectively).

In the example shown in FIG. 4, the single O-CU handles control-plane functions, user-plane functions, some non-real-time functions, and/or PDCP processing. The O-CU-CP (not shown) may communicate with at least one wireless service provider's Next Generation Cores (NGC) using a 5G NG-C interface and the O-CU-UP 409 may communicate with at least one wireless service provider's NGC using a 5G NG-U interface. The O-CU-UP 409 is communicatively coupled to the core network via switches 417 in the backhaul network 716.

Each O-DU 405 comprises a logical node hosting (performing processing for) Radio Link Control (RLC) and Media Access Control (MAC) layers, as well as optionally the upper or higher portion of the Physical (PHY) layer (where the PHY layer is split between the DU and RU). In other words, the O-DUs 405 implement a subset of the gNB functions, depending on the functional split (between O-CU and O-DU 405). In some configurations, the Layer-3 processing (of the 5G air interface) may be implemented in the O-CU and the Layer-2 processing (of the 5G air interface) may be implemented in the O-DU 405. The O-DU is communicatively coupled to the O-CU-UP 409 via switches in the midhaul network 411.

The O-RU 406 comprises a logical node hosting the portion of the PHY layer not implemented in the O-DU 405 (that is, the lower portion of the PHY layer) as well as implementing the basic RF and antenna functions. In some examples, the O-RUs 406 may communicate baseband signal data to the O-DUs 405 on Open Fronthaul CUS-Plane or Open Fronthaul M-plane interface. In some examples, the O-RU 406 may implement at least some of the Layer-1 and/or Layer-2 processing. In some configurations, the O-RUs 406 may have multiple ETHERNET ports and can communicate with multiple switches 713 in the fronthaul network 404.

Although the O-CU (including the O-CU-CP and O-CU-UP 409), O-DU 405, and O-RUs 406 are described as separate logical entities, one or more of them can be implemented together using shared physical hardware and/or software. For example, in the example shown in FIG. 4, for each cell, the O-CU (including the O-CU-CP and O-CU-UP 409) and O-DU 405 serving that cell could be physically implemented together using shared hardware and/or software, whereas each O-RU 406 would be physically implemented using separate hardware and/or software. Alternatively, the O-CU(s) (including the O-CU-CP and O-CU-UP 409) may be remotely located from the O-DU(s) 405.

In the example shown in FIG. 4, the base station 400 further includes a near-real time RAN intelligent controller (RIC) 732 and a non-real time RIC 434. The near-real time RIC 432 and the non-real time RIC 434 are separate entities in the O-RAN architecture and serve different purposes. In some examples, the near-real time RIC 432 is implemented as a standalone application in a cloud network. In other examples, the near-real time RIC 432 is embedded in the O-CU. In some examples, the non-real time RIC 434 is implemented as a standalone application in a cloud network. In other examples, the non-real time RIC 434 is integrated with a Device Management System (DMS) or Service Orchestration (SO) tool. The near-real time RIC 432 and/or the non-real time RIC 434 can also be deployed in other ways.

The non-real time RIC 434 is responsible for non-real time flows in the system (typically greater than or equal to 1 second) and configured to execute one or more machine learning models, which are also referred to as “rApps.” The near-real time RIC 432 is responsible for near-real time flows in the system (typically 10 ms to 1 second) and configured to execute one or more machine learning models, which are also referred to as “xApps.”

While not explicitly shown in FIG. 4, it should be understood that UEs communicating with the base station 400 shown in FIG. 4 can include the machine learning computing system 120 configured to operate as described above with respect to FIGS. 1A-3.

In some examples, the near-real time RIC 432 shown in FIG. 4 is configured to operate in a manner similar to the machine learning computing system 120 described above with respect to FIGS. 1A-3. In some such examples, the functionality of the machine learning computing system 120 is implemented as an xApp that is configured to run on the near-real time RIC 432. In some examples, the near-real time RIC 432 is configured to predict traffic parameters for SA UEs and NSA UEs in a manner similar to that described above, and the base station 400 is configured to allocate resources for admission control based on the predicted traffic parameters and service requirements for the base station 400. In some examples, the near-real time RIC 432 is configured to predict the operation mode for the base station and, optionally, the cause of the predicted operation mode, and the base station 400 is configured to perform preemptive action based on available resources, the predicted operation mode, and optionally the predicted cause for the predicted operation mode.

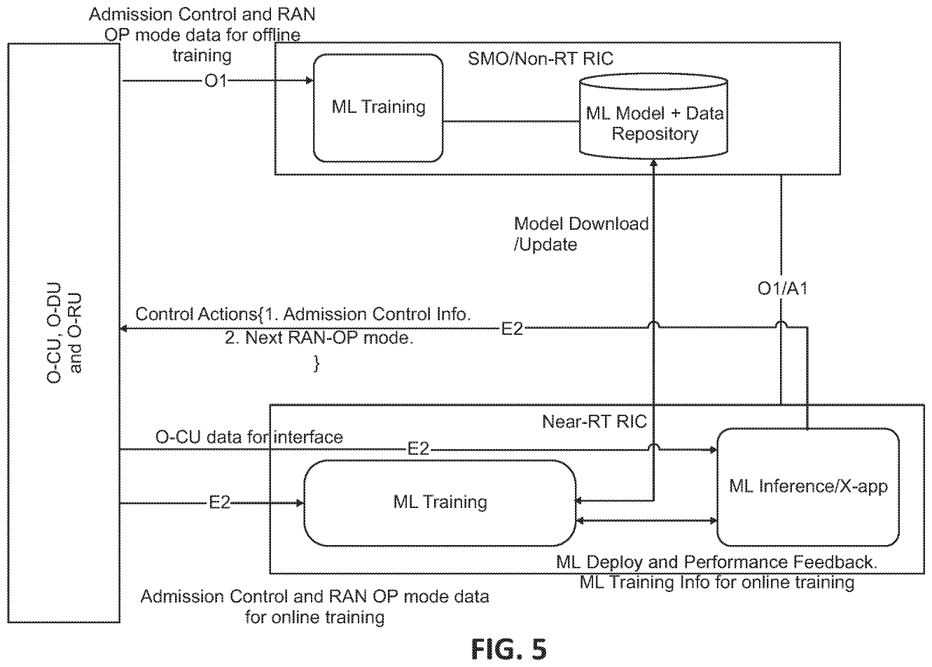

FIG. 5 is a diagram illustrating an example of how training and inference can be implemented in the base station of FIG. 4. In the example shown in FIG. 5, the admission control data (also referred to herein as performance indicators) and the RAN OP mode data (also referred to herein as operation mode data for the base station) are provided to respective machine learning training agents in the SMO/non-real time RIC and in the near-real time RIC. In the example shown in FIG. 5, the data is provided to the SMO/non-real time RIC via an O1 interface for offline training and provided to the near-real time RIC via an E2 interface for offline and/or online training. In some examples, the O-CU provides the data.

The ML model and data repository in the SMO/non-real time RIC can be utilized to store training data and the parameters for the machine learning model(s) used for inference in the near-real time RIC. In the example shown in FIG. 5, the ML inference/X-app block in the near-real time RIC is configured to receive data from the O-CU for inference. In some examples, the ML inference/X-app block is configured to receive the admission control and RAN-OP mode data from the O-CU. In some examples, the admission control data includes performance indicators for SA UEs and NSA UEs including, but not limited to, a total number of RRC Connection Establishment Requests, a total number of RRC Connection Rejections where the cause was resources not being available, a total number of GBR bearers mapped to a PDU session, a total number of non-GBR bearers mapped to a PDU session, a total number of PDU sessions, and/or a total number of 5QI bearers. In some examples, the performance indicators for SA UEs can also include a total number of inactive RRC contexts and a number of inactive RRC contexts that became active.

The ML inference/X-app block in the near-real time RIC uses the ML model(s) produced using the ML training to produce predicted traffic parameters and a predicted RAN-OP mode. In some examples, the predicted traffic parameters for NSA UEs or SA UEs include, but are not limited to, a total number of RRC Connection Establishment Requests, a total number of RRC Connection Rejections where the cause was resources not being available, a total number of GBR bearers mapped to a PDU session, a total number of non-GBR bearers mapped to a PDU session, a total number of PDU sessions, and/or a total number of 5QI bearers for a duration of time. In some examples, the predicted RAN-OP mode includes a standalone mode, a non-standalone mode, or both.

In the example shown in FIG. 5, the ML inference/X-app block in the near-real time RIC provides control actions to the O-CU, O-DU, and/or O-RU, which are based on the predicted traffic parameters (also referred to as admission control information in FIG. 5) and the predicted RAN-OP mode. In some examples, the control actions include resource allocation instructions generated based on the predicted traffic parameters for NSA UEs and SA UEs discussed above. In some examples, the resource allocation instructions reserve or otherwise allocate radio resources for admission control for NSA UEs and SA UEs based on the predicted traffic parameters for NSA UEs and SA UEs.

In some examples, the control actions include RAN-OP mode instructions generated based on the predicted RAN-OP mode discussed above. In some examples, the RAN-OP mode instructions indicate what RAN-OP mode the base station 400 will use for the next period of time. For example, the RAN-OP mode instructions can indicate whether the base station 400 will operate in a standalone mode, a non-standalone mode, or both for the next period of time.

Using the techniques described herein, a radio access network can predict the traffic parameters for standalone user equipment and non-standalone user equipment and allocate resources for the standalone user equipment and non-standalone user equipment in a manner that dynamically meets the SLA requirements of operators. Further, the techniques described herein enable prediction of future modes of operation for a base station and preemptive actions can be taken to improve user experience during operation mode changes due to network error or operator configuration.

The systems and methods described herein may be implemented in digital electronic circuitry, or with a programmable processor (for example, a special-purpose processor or a general-purpose processor such as a computer) firmware, software, or in combinations of them. Apparatus embodying these techniques may include appropriate input and output devices, a programmable processor, and a storage medium tangibly embodying program instructions for execution by the programmable processor. A process embodying these techniques may be performed by a programmable processor executing a program of instructions to perform desired functions by operating on input data and generating appropriate output. The techniques may advantageously be implemented in one or more programs that are executable on a programmable system including at least one programmable processor coupled to receive data and instructions from, and to transmit data and instructions to, a data storage system, at least one input device, and at least one output device. Generally, a processor will receive instructions and data from a read-only memory and/or a random-access memory. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and DVD disks. Any of the foregoing may be supplemented by, or incorporated in, specially-designed application-specific integrated circuits (ASICs).

### EXAMPLE EMBODIMENTS

Example 1 includes a system, comprising: at least one baseband unit (BBU) entity; a first radio unit communicatively coupled to the at least one BBU entity via a fronthaul network; one or more antennas communicatively coupled to the first radio unit, wherein the first radio unit is communicatively coupled to a respective subset of the one or more antennas; wherein the at least one BBU entity, the first radio unit, and the one or more antennas are configured to implement a base station for wirelessly communicating with user equipment in a first cell; and a machine learning computing system communicatively coupled to the at least one BBU entity, wherein the machine learning computing system is configured to: receive one or more performance indicators for standalone user equipment and one or more performance indicators for non-standalone user equipment from the at least one BBU entity; determine one or more predicted traffic parameters for standalone user equipment based on the received one or more performance indicators for standalone user equipment from the at least one BBU entity; and determine one or more predicted traffic parameters for non-standalone user equipment based on the received one or more performance indicators for non-standalone user equipment from the at least one BBU entity; wherein one or more components of the system are configured to allocate resources for standalone user equipment and/or non-standalone user equipment based on the one or more predicted traffic parameters for standalone user equipment, the one or more predicted traffic parameters for non-standalone user equipment, and service requirements for the base station.

Example 2 includes the system of Example 1, wherein the machine learning computing system is further configured to: receive operation mode data for the base station; determine a predicted operation mode for the base station based on the received operation mode data for the base station; and perform preemptive action for user equipment based on the predicted operation mode for the base station and available resources of the base station.

Example 3 includes the system of Example 2, wherein the machine learning computing system is configured to perform preemptive action for the user equipment by: handing over the user equipment from the first cell to a second cell; releasing and redirecting the user equipment from the first cell to the second cell; and/or changing an operation mode of the user equipment.

Example 4 includes the system of any of Examples 2-3, wherein the machine learning computing system is further configured to determine a predicted cause for the predicted operation mode for the base station.

Example 5 includes the system of any of Examples 1-4, wherein the one or more performance indicators for standalone user equipment and one or more performance indicators for non-standalone user equipment from the at least one BBU entity include: a total number of RRC Connection Establishment Requests; a total number of RRC Connection Rejections with a cause of resources not being available; a total number of Guaranteed Bit Rate (GBR) bearers mapped to a Protocol Data Unit (PDU) session; a total number of non-GBR bearers mapped to a PDU session; a total number of PDU sessions; and/or a total number of 5G Quality of Service Identifier (5QI) bearers.

Example 6 includes the system of any of Examples 1-5, wherein the one or more performance indicators for standalone user equipment from the at least one BBU entity include a number of inactive RRC contexts and a number of inactive RRC contexts that became active.

Example 7 includes the system of any of Examples 1-6, wherein the one or more predicted traffic parameters for standalone user equipment and the one or more predicted traffic parameters for non-standalone user equipment include: a predicted total number of RRC Connection Establishment Requests for standalone user equipment and non-standalone user equipment; a predicted total number of Guaranteed Bit Rate (GBR) bearers mapped to a Protocol Data Unit (PDU) session for standalone user equipment and non-standalone user equipment; a predicted total number of non-GBR bearers mapped to a PDU session for standalone user equipment and non-standalone user equipment; a predicted total number of PDU sessions for standalone user equipment and non-standalone user equipment; and/or a predicted total number of 5G Quality of Service Identifier (5QI) bearers for standalone user equipment and non-standalone user equipment.

Example 8 includes the system of any of Examples 1-7, wherein the machine learning computing system is further configured to determine a predicted total number of standalone user equipment that will be redirected to non-standalone mode and a predicted total number of non-standalone user equipment that will be redirected to standalone mode; wherein the one or more components of the system are further configured to allocate resources for standalone user equipment and/or non-standalone user equipment based on the predicted total number of standalone user equipment that will be redirected to non-standalone mode and the predicted total number of non-standalone user equipment that will be redirected to standalone mode.

Example 9 includes the system of any of Examples 1-8, wherein the machine learning computing system is configured to reserve radio resources for standalone user equipment and non-standalone user equipment based on the one or more predicted traffic parameters for standalone user equipment, the one or more predicted traffic parameters for non-standalone user equipment, and service requirements for the base station.

Example 10 includes the system of any of Examples 1-9, wherein one or more components of the system are configured to use scaling to increase radio resources for standalone user equipment and non-standalone user equipment based on the one or more predicted traffic parameters for standalone user equipment, the one or more predicted traffic parameters for non-standalone user equipment, and the service requirements for the base station.

Example 11 includes the system of any of Examples 1-10, wherein the at least one BBU entity includes a central unit communicatively coupled to a distributed unit, wherein the distributed unit is communicatively coupled to the first radio unit, wherein the central unit is configured to send the one or more performance indicators for standalone user equipment and the one or more performance indicators for non-standalone user equipment to the machine learning computing system, wherein the machine learning computing system is implemented in a radio access network intelligent controller.

Example 12 includes the system of any of Examples 1-11, wherein the machine learning computing system is further configured to: receive updated service requirements for the base station via an interface; and reallocate resources for standalone user equipment and/or non-standalone user equipment based on the one or more predicted traffic parameters for standalone user equipment, the one or more predicted traffic parameters for non-standalone user equipment, and the updated service requirements for the base station.

Example 13 includes a method, comprising: receiving one or more performance indicators for standalone user equipment and one or more performance indicators for non-standalone user equipment from at least one baseband unit (BBU) entity of a base station, wherein the base station includes the at least one BBU entity, a first radio unit, and one or more antennas configured to implement a base station for wirelessly communicating with user equipment in a cell; determining one or more predicted traffic parameters for standalone user equipment based on the received one or more performance indicators for standalone user equipment from the at least one BBU entity; determining one or more predicted traffic parameters for non-standalone user equipment based on the received one or more performance indicators for non-standalone user equipment from the at least one BBU entity; and allocating resources for standalone user equipment and/or non-standalone user equipment based on the one or more predicted traffic parameters for standalone user equipment, the one or more predicted traffic parameters for non-standalone user equipment, and service requirements for the base station.

Example 14 includes the method of Example 13, further comprising: receiving operation mode data for the base station; determining a predicted operation mode for the base station based on the received operation mode data for the base station; and performing preemptive action for user equipment based on the predicted operation mode for the base station and available resources of the base station.

Example 15 includes the method of Example 14, wherein performing preemptive action for user equipment based on the predicted operation mode for the base station and available resources of the base station includes: handing over the user equipment from the first cell to a second cell; releasing and redirecting the user equipment from the first cell to the second cell; and/or changing an operation mode of the user equipment.

Example 16 includes the method of any of Examples 13-15, wherein the one or more performance indicators for standalone user equipment and one or more performance indicators for non-standalone user equipment from the at least one BBU entity include: a total number of RRC Connection Establishment Requests for standalone user equipment and non-standalone user equipment; a total number of RRC Connection Rejections with a cause of resources not being available for standalone user equipment and non-standalone user equipment; a total number of Guaranteed Bit Rate (GBR) bearers mapped to a Protocol Data Unit (PDU) session for standalone user equipment and non-standalone user equipment; a total number of non-GBR bearers mapped to a PDU session for standalone user equipment and non-standalone user equipment; a total number of PDU sessions for standalone user equipment and non-standalone user equipment; and/or a total number of 5G Quality of Service Identifier (5QI) bearers for standalone user equipment and non-standalone user equipment.

Example 17 includes the method of any of Examples 13-16, wherein the one or more predicted traffic parameters for standalone user equipment and the one or more predicted traffic parameters for non-standalone user equipment include: a predicted total number of RRC Connection Establishment Requests for standalone user equipment and/non-standalone user equipment; a predicted total number of Guaranteed Bit Rate (GBR) bearers mapped to a Protocol Data Unit (PDU) session for standalone user equipment and non-standalone user equipment; a predicted total number of non-GBR bearers mapped to a PDU session for standalone user equipment and non-standalone user equipment; a predicted total number of PDU sessions for standalone user equipment and non-standalone user equipment; and/or a predicted total number of 5G Quality of Service Identifier (5QI) bearers for standalone user equipment and non-standalone user equipment.

Example 18 includes the method of any of Examples 13-17, wherein allocating resources for standalone user equipment and/or non-standalone user equipment includes reserving radio resources for standalone user equipment and non-standalone user equipment based on the one or more predicted traffic parameters for standalone user equipment, the one or more predicted traffic parameters for non-standalone user equipment, and service requirements for the base station.

Example 19 includes the method of any of Examples 13-18, wherein allocating resources for standalone user equipment and/or non-standalone user equipment includes using scaling to increase resources for standalone user equipment and non-standalone user equipment based on the one or more predicted traffic parameters for standalone user equipment, the one or more predicted traffic parameters for non-standalone user equipment, and service requirements for the base station.

Example 20 includes the method of any of Examples 13-19, further comprising: receiving updated service requirements for the base station via an interface; and reallocating resources for standalone user equipment and/or non-standalone user equipment based on the one or more predicted traffic parameters for standalone user equipment, the one or more predicted traffic parameters for non-standalone user equipment, and the updated service requirements for the base station.

A number of embodiments of the invention defined by the following claims have been described. Nevertheless, it will be understood that various modifications to the described embodiments may be made without departing from the spirit and scope of the claimed invention. Accordingly, other embodiments are within the scope of the following claims.

What is claimed is:

1. A system, comprising:
at least one baseband unit (BBU) entity;
a first radio unit communicatively coupled to the at least one BBU entity via a fronthaul network;
one or more antennas communicatively coupled to the first radio unit, wherein the first radio unit is communicatively coupled to a respective subset of the one or more antennas;
wherein the at least one BBU entity, the first radio unit, and the one or more antennas are configured to implement a base station for wirelessly communicating with user equipment in a first cell; and
a machine learning computing system communicatively coupled to the at least one BBU entity, wherein the machine learning computing system is configured to:
receive one or more performance indicators for standalone user equipment and one or more performance indicators for non-standalone user equipment from the at least one BBU entity;
determine one or more predicted traffic parameters for standalone user equipment based on the received one or more performance indicators for standalone user equipment from the at least one BBU entity; and
determine one or more predicted traffic parameters for non-standalone user equipment based on the received one or more performance indicators for non-standalone user equipment from the at least one BBU entity;
wherein one or more components of the system are configured to allocate resources for standalone user equipment and/or non-standalone user equipment based on the one or more predicted traffic parameters for standalone user equipment, the one or more predicted traffic parameters for non-standalone user equipment, and service requirements for the base station.

2. The system of claim 1, wherein the machine learning computing system is further configured to:
receive operation mode data for the base station;
determine a predicted operation mode for the base station based on the received operation mode data for the base station; and
perform preemptive action for user equipment based on the predicted operation mode for the base station and available resources of the base station.

3. The system of claim 2, wherein the machine learning computing system is configured to perform preemptive action for the user equipment by:
handing over the user equipment from the first cell to a second cell;
releasing and redirecting the user equipment from the first cell to the second cell;
and/or changing an operation mode of the user equipment.

4. The system of claim 2, wherein the machine learning computing system is further configured to determine a predicted cause for the predicted operation mode for the base station.

5. The system of claim 1, wherein the one or more performance indicators for standalone user equipment and one or more performance indicators for non-standalone user equipment from the at least one BBU entity include:
a total number of RRC Connection Establishment Requests;
a total number of RRC Connection Rejections with a cause of resources not being available;
a total number of Guaranteed Bit Rate (GBR) bearers mapped to a Protocol Data Unit (PDU) session;
a total number of non-GBR bearers mapped to a PDU session;
a total number of PDU sessions; and/or
a total number of 5G Quality of Service Identifier (5QI) bearers.

6. The system of claim 1, wherein the one or more performance indicators for standalone user equipment from the at least one BBU entity include a number of inactive RRC contexts and a number of inactive RRC contexts that became active.

7. The system of claim 1, wherein the one or more predicted traffic parameters for standalone user equipment and the one or more predicted traffic parameters for non-standalone user equipment include:
a predicted total number of RRC Connection Establishment Requests for standalone user equipment and non-standalone user equipment;
a predicted total number of Guaranteed Bit Rate (GBR) bearers mapped to a Protocol Data Unit (PDU) session for standalone user equipment and non-standalone user equipment;
a predicted total number of non-GBR bearers mapped to a PDU session for standalone user equipment and non-standalone user equipment;
a predicted total number of PDU sessions for standalone user equipment and non-standalone user equipment; and/or
a predicted total number of 5G Quality of Service Identifier (5QI) bearers for standalone user equipment and non-standalone user equipment.

8. The system of claim 1, wherein the machine learning computing system is further configured to determine a predicted total number of standalone user equipment that will be redirected to non-standalone mode and a predicted total number of non-standalone user equipment that will be redirected to standalone mode;
wherein the one or more components of the system are further configured to allocate resources for standalone user equipment and/or non-standalone user equipment based on the predicted total number of standalone user equipment that will be redirected to non-standalone mode and the predicted total number of non-standalone user equipment that will be redirected to standalone mode.

9. The system of claim 1, wherein the machine learning computing system is configured to reserve radio resources for standalone user equipment and non-standalone user equipment based on the one or more predicted traffic parameters for standalone user equipment, the one or more predicted traffic parameters for non-standalone user equipment, and service requirements for the base station.

10. The system of claim 1, wherein one or more components of the system are configured to use scaling to increase radio resources for standalone user equipment and non-standalone user equipment based on the one or more predicted traffic parameters for standalone user equipment, the one or more predicted traffic parameters for non-standalone user equipment, and the service requirements for the base station.

11. The system of claim 1, wherein the at least one BBU entity includes a central unit communicatively coupled to a distributed unit, wherein the distributed unit is communicatively coupled to the first radio unit, wherein the central unit is configured to send the one or more performance indicators for standalone user equipment and the one or more performance indicators for non-standalone user equipment to the machine learning computing system, wherein the machine learning computing system is implemented in a radio access network intelligent controller.

12. The system of claim 1, wherein the machine learning computing system is further configured to:
receive updated service requirements for the base station via an interface; and
reallocate resources for standalone user equipment and/or non-standalone user equipment based on the one or more predicted traffic parameters for standalone user equipment, the one or more predicted traffic parameters for non-standalone user equipment, and the updated service requirements for the base station.

13. A method, comprising:
receiving one or more performance indicators for standalone user equipment and one or more performance indicators for non-standalone user equipment from at least one baseband unit (BBU) entity of a base station, wherein the base station includes the at least one BBU entity, a first radio unit, and one or more antennas configured to implement a base station for wirelessly communicating with user equipment in a cell;
determining one or more predicted traffic parameters for standalone user equipment based on the received one or more performance indicators for standalone user equipment from the at least one BBU entity;
determining one or more predicted traffic parameters for non-standalone user equipment based on the received one or more performance indicators for non-standalone user equipment from the at least one BBU entity; and
allocating resources for standalone user equipment and/or non-standalone user equipment based on the one or more predicted traffic parameters for standalone user equipment, the one or more predicted traffic parameters for non-standalone user equipment, and service requirements for the base station.

14. The method of claim 13, further comprising:
receiving operation mode data for the base station;
determining a predicted operation mode for the base station based on the received operation mode data for the base station; and
performing preemptive action for user equipment based on the predicted operation mode for the base station and available resources of the base station.

15. The method of claim 14, wherein performing preemptive action for user equipment based on the predicted operation mode for the base station and available resources of the base station includes:
handing over the user equipment from the first cell to a second cell;
releasing and redirecting the user equipment from the first cell to the second cell;
and/or changing an operation mode of the user equipment.

16. The method of claim 13, wherein the one or more performance indicators for standalone user equipment and one or more performance indicators for non-standalone user equipment from the at least one BBU entity include:
a total number of RRC Connection Establishment Requests for standalone user equipment and non-standalone user equipment;
a total number of RRC Connection Rejections with a cause of resources not being available for standalone user equipment and non-standalone user equipment;
a total number of Guaranteed Bit Rate (GBR) bearers mapped to a Protocol Data Unit (PDU) session for standalone user equipment and non-standalone user equipment;
a total number of non-GBR bearers mapped to a PDU session for standalone user equipment and non-standalone user equipment;
a total number of PDU sessions for standalone user equipment and non-standalone user equipment; and/or
a total number of 5G Quality of Service Identifier (5QI) bearers for standalone user equipment and non-standalone user equipment.

17. The method of claim 13, wherein the one or more predicted traffic parameters for standalone user equipment and the one or more predicted traffic parameters for non-standalone user equipment include:
a predicted total number of RRC Connection Establishment Requests for standalone user equipment and/non-standalone user equipment;
a predicted total number of Guaranteed Bit Rate (GBR) bearers mapped to a Protocol Data Unit (PDU) session for standalone user equipment and non-standalone user equipment;
a predicted total number of non-GBR bearers mapped to a PDU session for standalone user equipment and non-standalone user equipment;
a predicted total number of PDU sessions for standalone user equipment and non-standalone user equipment; and/or
a predicted total number of 5G Quality of Service Identifier (5QI) bearers for standalone user equipment and non-standalone user equipment.

18. The method of claim 13, wherein allocating resources for standalone user equipment and/or non-standalone user equipment includes reserving radio resources for standalone user equipment and non-standalone user equipment based on the one or more predicted traffic parameters for standalone user equipment, the one or more predicted traffic parameters for non-standalone user equipment, and service requirements for the base station.

19. The method of claim 13, wherein allocating resources for standalone user equipment and/or non-standalone user equipment includes using scaling to increase resources for standalone user equipment and non-standalone user equipment based on the one or more predicted traffic parameters for standalone user equipment, the one or more predicted traffic parameters for non-standalone user equipment, and service requirements for the base station.

20. The method of claim 13, further comprising:
receiving updated service requirements for the base station via an interface; and
reallocating resources for standalone user equipment and/or non-standalone user equipment based on the one or more predicted traffic parameters for standalone user equipment, the one or more predicted traffic parameters for non-standalone user equipment, and the updated service requirements for the base station.
